(19) United States
(12) Patent Application Publication
(10) Pub. No.: US 2015/0000475 A1
(43) Pub. Date: Jan. 1, 2015

(54) IMPACT SOCKET ADAPTER

(71) Applicant: Thorsen Tools, Inc., Ontario, CA (US)

(72) Inventor: David MEHOLOVITCH, Glendora, CA (US)

(21) Appl. No.: 13/931,427

(22) Filed: Jun. 28, 2013

(51) Int. Cl. B25B 13/06; B25B 19/00; B25B 23/00

(52) U.S. Cl. CPC B25B 13/06; B25B 23/0035; B25B 19/00
USPC 81/121.1

(57) ABSTRACT

A tool includes a shaft, a first head at a first end of the shaft, the first head comprising a female socket of a first size, and a second head at a second end of the shaft, the second head comprising a male socket of a second size. The first size and the second size are different from one another.

### BACKGROUND OF THE INVENTION

1. Field of the Invention

Embodiments of the present invention generally relate to a hand tool. More specifically, embodiments of the present invention relate to a hand tool that adapts a first size of socket to fit a second size of socket, as well as provide an extension for an impact driver.

2. Description of the Related Art

Impact socket adapters are well known in the art, and are commonly used to provide an extension for an impact driver. Socket adapters include a shank with two ends. The first end includes a male socket head, and the second end includes a female socket head. The shank may be of various lengths and can serve as an extension between the two types of sockets when it is hard for an impact driver to reach a particular fastener. Both the male and female socket heads are typically sized the same. For example, a ½ inch socket adapter would include a ½ inch female socket head and a ½ inch male socket head.

At times, when using an impact driver with a certain size of socket, it may be desired to use an extension as well as change to a socket of a different size. In such instances, it is necessary to locate the different size of socket, replace the existing socket on the impact driver, and then add an adapter to the newly added socket. In order to be more efficient, there is a need for a tool that may provide an adapter that will provide both an extension and convert the socket to a different size of socket in one tool.

### SUMMARY OF THE INVENTION

The present invention generally relates to a tool that includes a shaft, a first head at a first end of the shaft, the first head comprising a female socket of a first size, and a second head at a second end of the shaft, the second head comprising a male socket of a second size. The first size and the second size are different from one another.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A is a perspective view of an embodiment of an impact socket adapter of the present invention with a first size of shaft.

FIG. 1B is a perspective view of an embodiment of the impact socket adapter of the present invention with a second size of shaft.

FIG. 1C is a perspective view of an embodiment of the impact socket adapter of the present invention with a third size of shaft.

### DETAILED DESCRIPTION

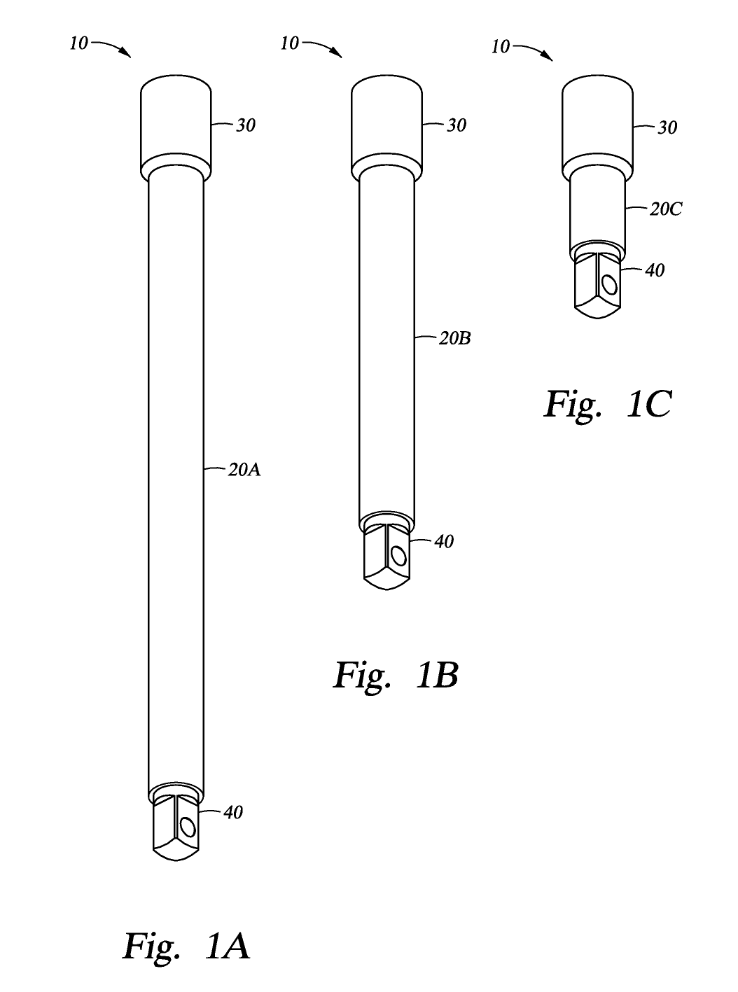

The present invention relates to a hand tool that serves as an adapter to an impact driver. More specifically, the tool of the present invention converts a socket of one size to a socket of a different size as well as provides an extension between the impact driver and a fastener. FIGS. 1A-1C show an embodiment of the tool of the present invention with different size shanks for various extensions.

The tool 10 of the present invention includes a shank 20, a first head 30 located at one end of the shank 20 and a second head 40 located at a second end of the shank 20. The first head 30 or the second head 40 may be integral with the shank 20. Alternatively, the first head 30 or the second head 40 may be removable from the shank 20. The first head 30 comprises a first socket of a first size, and may be a female socket. The second head 40 comprises a second socket of a second size and may be a male socket. The first size and second size are different from one another. For example, in FIGS. 1A-1C, the first head 30 provides a ½ inch female socket, and the second head 40 provides a ⅜ inch male socket. Other sizes and combination of sizes are contemplated. Also, as shown in FIGS. 1A-1C, the shank provides an extension for an impact driver when the impact driver has difficulty reaching a fastener. FIG. 1A, shows a tool 10 that provides a first extension. For example, the first extension may be 8¼ inches. FIG. 1B shows a tool 10 that provides a second extension. For example, the second extension may be 5½ inches. FIG. 1C shows a tool 10 that provides a third extension. For example, the third extension may be 2½ inches. Other extension sizes are also contemplated.

In use, the second head 40 (male) of the tool 10 is simply coupled to a female socket already in position on the impact driver. Because the first head 30 and second head 40 are different, and the shank 20 provides an extension, the impact driver is provided with both a different size socket, and an extension, by using one tool 10, instead of having to switch out both the socket and the adapter to achieve the same results.

While the foregoing is directed to embodiments of the present invention, other and further embodiments of the invention may be devised without departing from the basic scope thereof, and the scope thereof is determined by the claims that follow.

1. A tool, comprising:
a shaft;
a first head at a first end of the shaft, the first head comprising a female socket of a first size; and
a second head at a second end of the shaft, the second head comprising a male socket of a second size, the first size and second size being different from one another.

2. The tool of claim 1, wherein the shaft comprises an extension for an impact driver.

3. The tool of claim 2, wherein the shaft is 8¼ inches in length.

4. The tool of claim 2, wherein the shaft is 5½ inches in length.

5. The tool of claim 2, wherein the shaft is 2½ inches in length.

6. The tool of claim 1, wherein the first head and the second head are integral with the shaft.

7. The tool of claim 1, wherein the first head and the second head are removable from the shaft.

8. A tool for providing an extension to an impact driver, comprising:
a shaft;
a first head integral to and at a first end of the shaft, the first head comprising a female socket of a first size; and
a second head integral to and at a second end of the shaft, the second head comprising a male socket of a second size, the first size and second size being different from one another.

9. The tool of claim 8, wherein the second head is operable to connect to a corresponding sized female socket of the impact driver.

10. The tool of claim 8, wherein the first head is operable to connect to a corresponding sized male socket of the impact driver.

11. The tool of claim 8, wherein the first head is ½ inches in diameter, and the second head is ⅜ inches in diameter.
